(19) United States
(12) Patent Application Publication
(10) Pub. No.: US 2007/0058082 A1
(43) Pub. Date: Mar. 15, 2007

(54) Saturation correction for color pictures

(75) Inventor: Michel Nieuwenhuizen, EINDHOVEN (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/572,468

(22) PCT Filed: Sep. 20, 2004
(86) PCT No.: PCT/IB04/51797

§ 371 Date: Mar. 20, 2006

Related U.S. Application Data
(60) Provisional application No. 60/504,996, filed on Sep. 22, 2003.

(51) Int. Cl. H04N 9/68

(52) U.S. Cl. 348/645

(57) ABSTRACT

The present invention is directed to a method of saturation correction. The method includes converting a luminance signal and at least one color difference signal into a color signal. Detecting if the color signal has a negative value. Inverting the color signal to produce a correction value. Further, adding the correction value to the luminance signal.

The present invention relates generally to video processing, and more particularly, to a method of saturation correction that corrects for negative values that occur in color output signals.

In color television systems such as the National Television System Committee (NTSC) and Phase Alternation Line (PAL), the YUV domain is utilized for video transmission. This means that video information is transmitted by a luminance signal and a chrominance signal. The luminance signal provides brightness information while the chrominance signal provides color information. The luminance signal is derived from gamma-corrected red, green and blue signals as follows:
Y=0.299R′+0.587R′+0.114B′ (1)

The chrominance signal is made up of color difference signals that are combined with the luminance signal to produce red, green and blue color signals that are used to produce a color picture. These color difference signals specify the differences between the luminance signal and the gamma-corrected red, green and blue color signals as follows:
U=0.492(B′−Y)
V=0.877(R′−Y) (2)

Saturation control in color television is based on the amplification of the color difference signals relative to the luminance signal. Saturation control performed in the YUV domain sometimes causes colors to be amplified that cannot be reproduced correctly. In one case, this is caused by one of the RGB color output signals being clipped to a maximum level. However, this is a problem usually for very bright colors.

More common is that an output RGB color signal may have a negative value. In saturation control, only the color difference signals U,V are amplified and not the luminance signal Y. Thus, in converting from the YUV to RGB domain, one of the output RGB color signals may have a negative value. This may happen even at moderate luminance levels. Since a negative value cannot be displayed, this value will be clipped by the display. This clipping visually causes a wrong hue or a dull color. In a color picture display, this may not be a problem for all colors. However, dullness is especially apparent for yellow.

In view of the above, the present invention is directed to a method of saturation correction. The method includes converting a luminance signal and at least one color difference signal into a color signal. Detecting if the color signal has a negative value. Inverting the color signal to produce a correction value. Further, adding the correction value to the luminance signal.

In some examples, the conversion step includes converting a luminance signal and two color difference signals into RGB color signals. Further, either taking the minimum of the RGB color signals or just selecting a B color signal.

In other examples, the conversion step includes scaling the at least one color difference signal to produce a scaled color difference signal. Further, adding a negative of both the scaled color difference signal and the luminance signal.

Referring now to the drawings were like reference numbers represent corresponding parts throughout:

FIG. 1 is a diagram showing one example of the saturation correction according to the present invention;

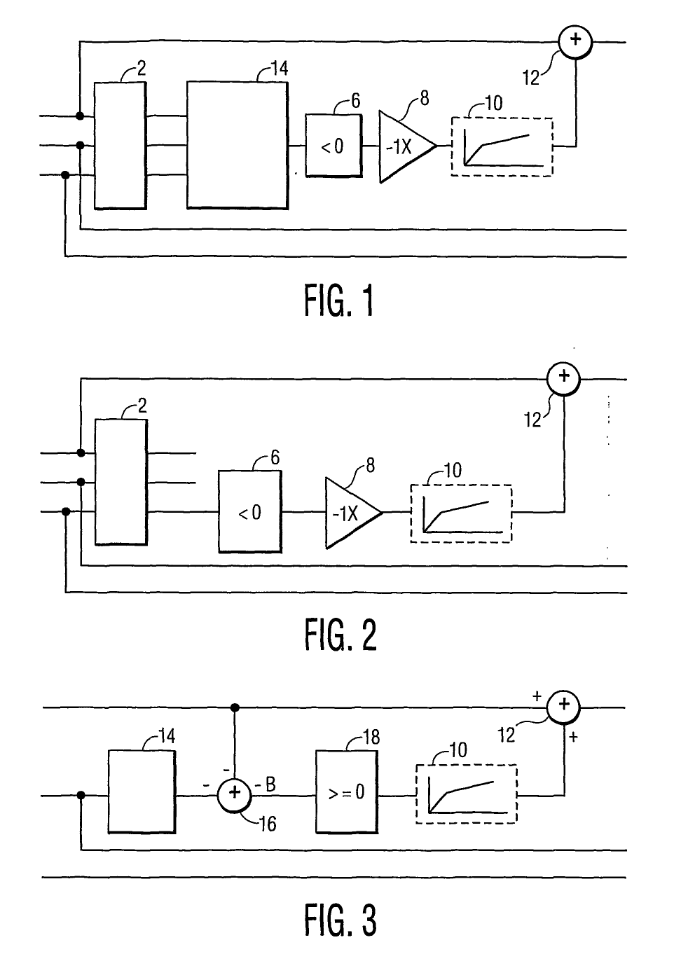

FIG. 2 is a diagram showing another example of saturation correction according to the present invention;

FIG. 3 is a diagram showing another example of saturation correction according to the present invention;

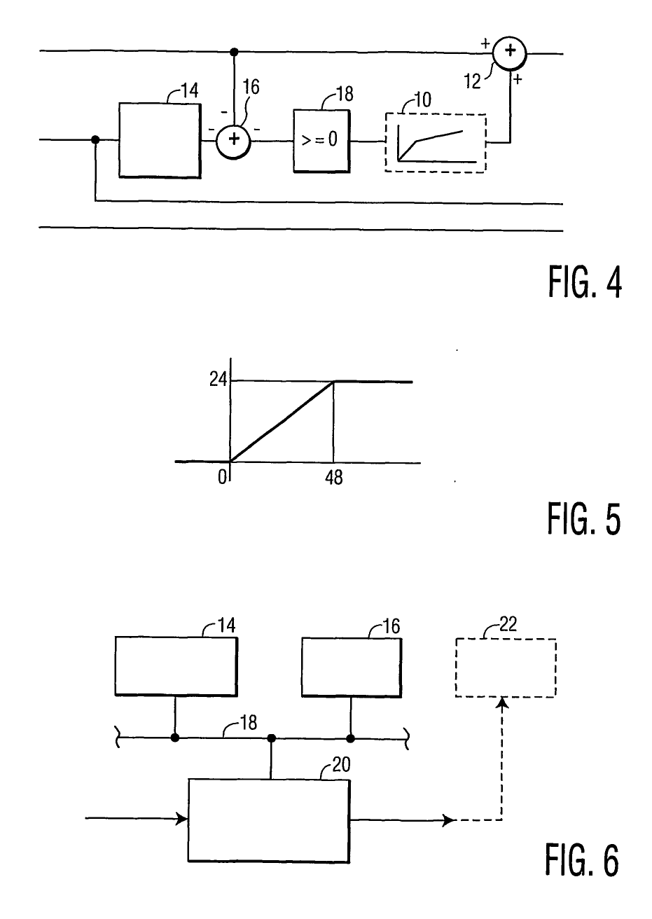

FIG. 4 is a diagram showing another example of saturation correction according to the present invention;

FIG. 5 is a diagram showing one example of non-linear curve;

FIG. 6 is a diagram showing one example of a device according to the present invention.

As previously described, saturation control performed in the YUV domain may cause a RGB color output signal to have a negative value. Since a negative value cannot be displayed, this can cause colors to be appear visually dull in the displayed picture. Such dullness is especially apparent for yellow. In order to correct for this dullness, the present invention utilizes saturation correction that detects these negative values and then adds a positive of these detected values to the luminance signal.

One example of the saturation correction according to the present invention is shown in FIG. 1. In step 2, a luminance signal Yin and two color difference signals Uin,Vin are converted into RGB color signals. This conversion may be performed according to the following:
R=Y+1.140V
G=Y−0.394U−0.581V
B=Y+2.032U (3)

In step 4, the minimum of the RGB color signals is taken. Thus, the RGB color signal with the lowest value will be selected. If one of the RGB color signals happens to be negative, then that particular value is selected.

In step 6, it is detected whether the RGB color signal provided by step 4 has a negative value. In this example, this is accomplished by clipping the output signal if the input value is greater than zero (0). For example, if the input value is twenty (20), then the output value is zero (0). If the input value is negative twenty (−20), then the output value is negative twenty (−20). In this way, only RGB color signals with a negative value are passed along for further processing.

In step 8, the RGB color signals provided by step 6 are inverted. Thus, the RGB color signals detected to have a negative value will be converted into a positive value.

As can be seen from FIG. 1, a non-linear adjustment step 10 is enclosed in a dotted box. This implies that this feature may or may not be included in the saturation correction according to the present invention. If it is not included, the output of the inverting 8 is provided directly to the adding step 12. If it is included, the output of the inverting 8 will be adjusted according to a non-linear curve in step 10. This will prevent the value of the RGB-color signal detected as being negative from being to large, which could cause an over-correction when the color picture is displayed. Thus, the non-linear adjustment step 12 acts as a soft clipper to avoid such an over-correction. One example of a non-linear curve will be described below in regard to FIG. 5.

In step 12, the RGB color values provided from either step 8 or 10 are added to the luminance signal Yn to produce an output luminance signal Yout. For example, if a blue color signal is detected as having a negative value, its positive value will be added to the luminance signal Yn to produce an output luminance signal Yout. Thus, the blue color signal produced by converting the output signals Yout, Uout, Vout into RGB Color signals will not be negative. Therefore, clipping in the displayed picture will be prevented for colors that are produced by the blue color signal such as yellow.

Another example of the saturation correction according to the present invention is shown in FIG. 2. As can be seen, this example is this same as the example of FIG. 1 except that a minimum of the RGB color signals is not taken. Instead, only the B color signals are selected for further processing. As previously described, dullness due to a color signal having a negative value is more apparent in yellow. Since the B color signals contributes to yellow, it may be more efficient to just process the B color signals.

During operation, the example of FIG. 2 will then operate the same as described in regard to FIG. 1, except that only the B color signals are processed. In step 2, the luminance Yin and two color difference signals Uin,Vin are converted into RGB color signals. In step 4, the B color signals are selected and it is then detected whether any of the B color signals has a negative value. The example of FIG. 2 will further process the B color signals the same as previously described in regard to the example of FIG. 1. Therefore, no further description is necessary.

Another example of the saturation correction according to the present invention is shown in FIG. 3. In this example, the three input signals Yin,Uin,Vin are not converted into the three RGB signals. Instead, the luminance signal Yin and one of the difference signals Uin are used to produce negative B color signals. This conversion is accomplished by steps 14,16. Since this enables a simpler circuit to be used, this may provide a more efficient way of implementing the saturation correction according to the present invention.

In step 14, one of the difference signals Uin is scaled to be in the form of B′−Y. For example, if Uin is the same as in Equation 2, Uin would be divided by a factor of “0.492”. In step 16, the negative of both the luminance signal Yin and the output of the scaling 14 is added. This produces a negative of the B color signals. As described above, steps 14,16 convert the luminance signal Yin and one of the difference signals Uin into B color signals. Further, as a result of step 16, the B color signal is also inverted. This futher simplifies this example by not requiring another inverting step as in the previous examples.

In step 18, it is detected weather the B color signals originally had a negative value. In this example, this is accomplished by clipping the output signal if the input value is less than or equal to zero (0). For example, if a B color signal originally had a value of twenty (20), then the output of the adding 16 would be a negative twenty (−20) and the output of step 18 would be zero (0). If a B color signal originally had a value of negative twenty (−20), then the output of the adding 16 would be twenty (20) and the output of step 18 would be zero (20). In this way, only the B color signals that originally had a negative value are passed along for further processing.

As can be seen, the rest of FIG. 3 is the same as in the other two examples. Similarly, this example also may include a non-linear adjustment step 10. As in the other examples, the non-linear adjustment step changes the B color signals detected as being negative according to a non-linear curve to prevent an over-correction.

Similarly, the example of FIG. 3 also includes an adding step 12 to add the value of the B color signals from either step 18 or 10 to the luminance signal Yn to produce a luminance signal Yout As in the other embodiments, this provides a correction for a B color signal detected as being negative when the output signals Yout, Uout, Vout are converted into RGB color signals to be displayed.

Another example of the saturation correction according to the present invention is shown in FIG. 4. As can be seen, in this example the difference signals Cbin, Crin are used. These difference signals Cbin, Crin are similar to the Uin, Vin except for being scaled in the digital domain. In this example, we are assuming that the difference signals Cbin, Crin are represented in a two's compliment code. Thus, the example of FIG. 4 operates the same as the example of FIG. 3 except for the scaling 14. In this example, the difference signal Cbin is divided by a constant factor such as a value of “0.564”. As a result of the scaling 14, the difference signal Cbin is in the form of B′−Y.

One example of non-linear curve that any be used in the non-linear adjustment step is shown in FIG. 5. As previously described, if included, the non-linear adjustment step adjusts the value of the color signal that is added to the luminance signal Yn according to a non-linear curve to prevent over saturation. In this example, for a value in the range of 0-48, the value of added to the luminance signal Yn will be divided by one half. Further, for a value greater than forty-eight (48), the value added to the luminance signal Yn will be twenty-four (24). However, it should be noted that the non-linear curve shown in FIG. 5 is just an example. Thus, other non-linear curves are also contemplated. For example, the slope of the slanted line may be changed. Further, the amplitude of the flat portion may also change.

One example of a device according to the present invention is shown in FIG. 6. By way of example, the device may represent a television, a set-top box, a personal computer, a printer or an optical recording device such as a digital video recorder or a DVD as well as portions or combinations of these and other devices. The device includes a processor 14, memory 16, a bus 18 and one or more input/output devices 20. In case of the device being a television or a computer, it would also include a display 22.

The input/output devices 20, processor 14 and memory 16 communicate over the bus 18. Input signals Yin,Uin,Vin are processed in accordance with one or more software programs stored in memory 16 and executed by processor 14 in order to generate output color signals Ro′ Go′ Bo′. These output color signals Ro′ Go′ Bo′ can either be stored in the memory 16 or sent to the display 22 to produce a color picture.

In particular, the software programs stored in the memory 14 may include one or more of the saturation correction methods of FIGS. 1-4. Further, the software programs stored in the memory 14 may also include other video signal processing algorithms such as saturation control. In this embodiment, the saturation correction method along with the other algorithms are implemented by computer readable code executed by the processor 14. Further, the code is stored in the memory 16. In other embodiments, hardware circuitry may be used in place of, or in combination with, software instructions to implement the invention.

While the present invention has been described above in terms of specific examples, it is to be understood that the invention is not intended to be confined or limited to the examples disclosed herein. Therefore, the present invention is intended to cover various structures and modifications thereof included within the spirit and scope of the appended claims.

1. A method of saturation correction, comprising the steps of:
converting a luminance signal and at least one color difference signal into a color signal (2 or 14,16);
detecting if the color signal has a negative value (6 or 18);
inverting the color signal to produce a correction value (8 or 16); and
adding the correction value to the luminance signal (12).

2. The method of claim 1, which further includes adjusting the correction value according to a non-linear curve (10).

3. The method of claim 1, wherein the converting step includes converting a luminance signal and two color difference signals into RGB color signals (2).

4. The method of claim 3, which further includes taking the minimum of the RGB color signals (4).

5. The method of claim 3, which further includes selecting a B color signal.

6. The method of claim 1, wherein the converting step includes:
scaling the at least one color difference signal (14) to produce a scaled color difference signal; and
adding a negative of both the scaled color difference signal and the luminance signal (16).

7. A device for performing saturation correction, comprising:
means for converting a luminance signal and at least one color difference signal into a color signal (2 or 14,16);
means for detecting if the color signal has a negative value (6 or 18);
means for inverting the color signal to produce a correction value (8 or 16); and
means for adding the correction value to the luminance signal (12).

8. The device of claim 7, which further includes means for adjusting the correction value according to a non-linear curve (10).

9. The device of claim 7, wherein the converting means includes means for converting a luminance signal and two color difference signals into RGB color signals (2).

10. The device of claim 9, which further includes means for taking the minimum of the RGB color signals (4).

11. The device of claim 9, which further includes means for selecting a B color signal.

12. The device of claim 7, wherein the converting means includes:
means for scaling the at least one color difference signal (14) to produce a scaled color difference signal; and
means for adding a negative of both the scaled color difference signal and the luminance signal (16).

13. A memory medium including code for performing saturation correction, the code comprising:
a code for converting a luminance signal and at least one color difference signal into a color signal (2 or 14,16);
a code for detecting if the color signal has a negative value (6 or 18);
a code for inverting the color signal to produce a correction value (8 or 16); and
a code for adding the correction value to the luminance signal (12).

14. The memory medium of claim 13, which further includes a code for adjusting the correction value according to a non-linear curve (10).

15. The memory medium of claim 13, wherein the converting code includes a code for converting a luminance signal and two color difference signals into RGB color signals (2).

16. The memory medium of claim 15, which further includes a code for taking the minimum of the RGB color signals (4).

17. The memory medium of claim 15, which further includes a code for selecting a B color signal.

18. The memory medium of claim 13, wherein the converting step includes:
a code for scaling the at least one color difference signal (14) to produce a scaled color difference signal; and
a code for adding a negative of both the scaled color difference signal and the luminance signal (16).
